(19) United States
(12) Patent Application Publication
(10) Pub. No.: US 2007/0022970 A1
(43) Pub. Date: Feb. 1, 2007

(54) Animal support apparatus and method for providing physical therapy to animals

(76) Inventor: Paul B. Newman, Napa, CA (US)

Correspondence Address: WOOD AND EISENBERG, PLLC, 2121 Eisenhower Ave, Suite 200, Alexandria, VA, 22314, US

(21) Appl. No.: 11/191,994

(22) Filed: Jul. 29, 2005

(51) Int. Cl. A01D 15/00

(52) U.S. Cl. 119/700

(57) ABSTRACT

An apparatus and method for providing physical therapy to animals. In one embodiment, the invention is an animal support apparatus including a base, a first vertical member attached to the base, a first horizontal support member attached to the first vertical member, a second vertical member attached to the first horizontal member, and a second horizontal member attached to the second vertical member. In another embodiment, the invention is a method for providing physical therapy to animals, including the steps of: supporting an animal above a treadmill by means of a harness connected to an artificial support member, and allowing at least one of the animal's feet to come into contact with the treadmill in such a manner that the treadmill aids the animal by exercising at least one leg of the animal. In a further embodiment, the invention is a physical therapy apparatus in combination with a treadmill.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention is directed to an animal support apparatus and method for providing physical therapy to animals. More specifically, the invention is an animal support apparatus that works in conjunction with a typical treadmill to provide physical exercise for injured animals in need of such exercise.

### BACKGROUND OF THE INVENTION

Family pets, particularly dogs and cats, provide an immense amount of joy and comfort to their owners, especially lonely seniors, single parents, and children. As much as we might love our pets and seek to protect them from harm and injury, it is nevertheless true that pets such as dogs and cats can suffer from severe injuries, perhaps from running in front of a moving vehicle or automobile. Sadly, many animals are put to death in the vain belief that nothing can be done to treat their injuries.

### SUMMARY OF THE INVENTION

An apparatus and method for providing physical therapy to animals. In one embodiment, the invention is an animal support apparatus including a base, a first vertical member attached to the base, a first horizontal support member attached to the first vertical member, a second vertical member attached to the first horizontal member, and a second horizontal member attached to the second vertical member. In another embodiment, the invention is a method for providing physical therapy to animals, including the steps of: supporting an animal above a treadmill by means of a harness connected to an artificial support member, and allowing at least one of the animal's feet to come into contact with the treadmill in such a manner that the treadmill aids the animal by exercising at least one leg of the animal. In a further embodiment, the invention is a physical therapy apparatus in combination with a treadmill.

### BRIEF DESCRIPTION OF THE DRAWINGS

FIG. 1A shows an environmental, perspective view of an animal support apparatus of the present invention.

FIG. 1B shows a perspective view of the animal support apparatus of FIG. 1A.

FIG. 2A shows an environmental, side view of the animal support apparatus of FIG. 1A.

FIG. 2B shows another environmental, side view of the animal support apparatus of FIG. 1A.

FIG. 3 shows an environmental, rear view of the animal support apparatus of FIG. 1A.

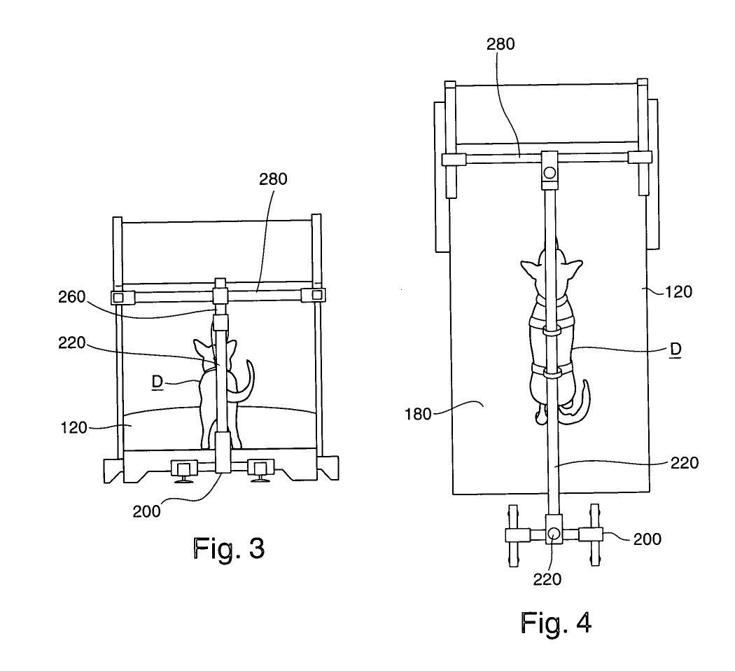

FIG. 4 shows an environmental, top view of the animal support apparatus of FIG. 1A.

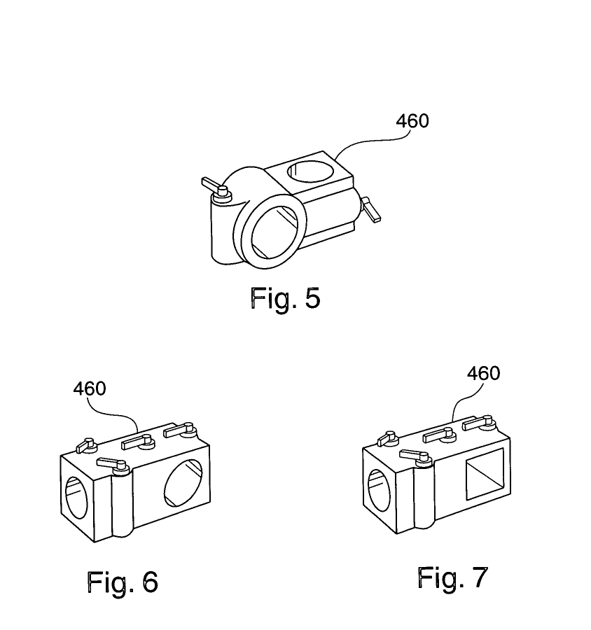

FIGS. 5, 6, 7 and 8 show various clamps used to adjust and hold together the animal support apparatus of FIG. 1A.

Similar reference characters denote corresponding features consistently throughout the attached drawings.

### DETAILED DESCRIPTION OF THE PREFERRED EMBODIMENTS

This invention is directed to an animal support apparatus and method for providing physical therapy to animals. More specifically, the invention is a physical therapy apparatus for providing physical therapy to animals. More specifically, the invention is a physical therapy apparatus that works in conjunction with a typical treadmill to provide physical exercise for injured animals in need of such exercise. Still more specifically, the invention is a physical therapy apparatus in combination with a treadmill for providing physical therapy to animals.

The animal support apparatus of the present invention is indicated generally by the numeral 100.

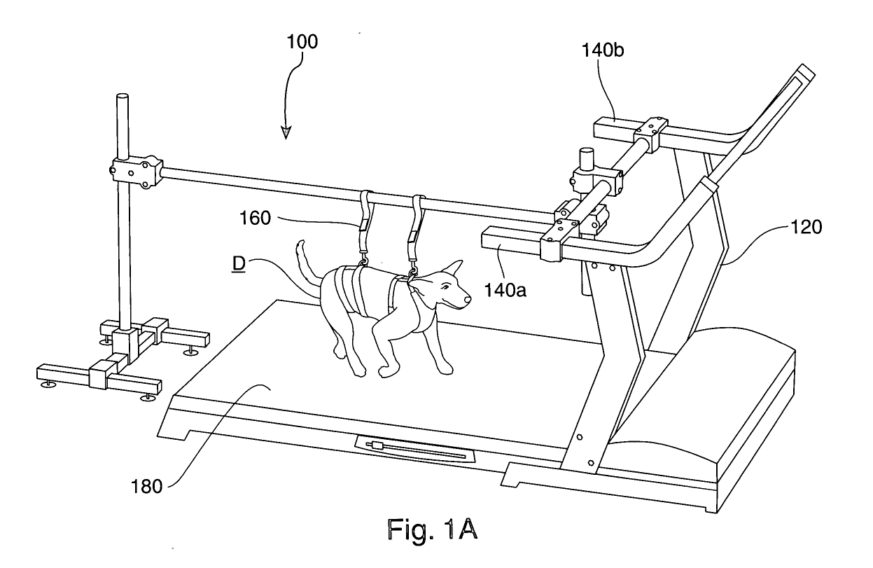

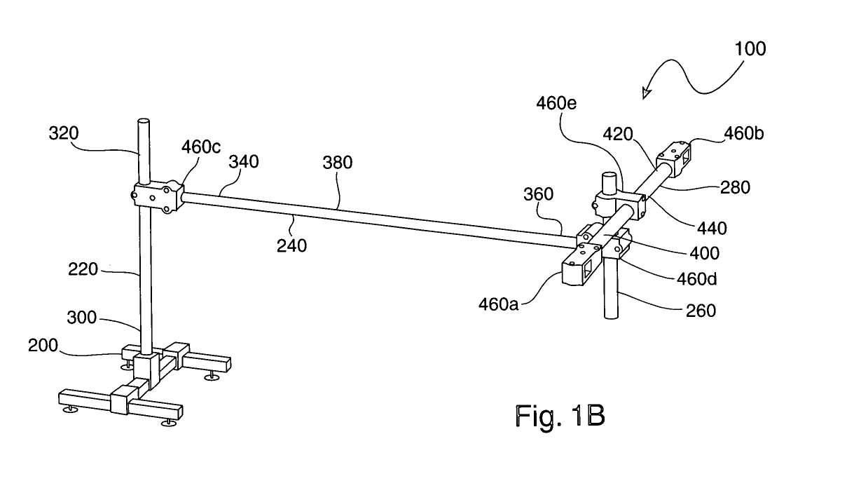

FIG. 1A shows an environmental, perspective view of the animal support apparatus 100 fitted to a treadmill 120, and more particularly to a treadmill 120 having first and second treadmill support arms 140a and 140b. At least one animal harness 160 is shown attached to the animal support apparatus 100 and a dog D attached thereto which is shown supported and suspended above a treadmill track 180 of treadmill 120. The at least one animal harness 160 optionally includes adjustable straps.

It should be understood that the animal support apparatus 100 is suitable for supporting a large animal such as, but not limited to, a large dog or a foal, or a small animal such as a cat or small dog. It is envisaged that other animals such as a miniature horse could be harnessed to the device 100 and suspended over a treadmill track 180. Thus, the device 100 is not limited to supporting one type of animal.

FIG. 1B shows a perspective view of the animal support apparatus 100 shown in FIG. 1A. The animal support apparatus 100 comprises: a base 200, a first vertical member 220, a first horizontal support member 240, a second vertical member 260, and a second horizontal member 280.

The first horizontal support member 240 acts as an artificial support member by supporting the weight of an animal, such as a four-legged animal (or an animal such as a three-legged dog that has lost a leg), above a moving track 180 of a treadmill 120. Thus, device 100 makes it possible to provide physical therapy to animals.

The first vertical member 220 includes first and second opposite ends 300 and 320, of which first end 300 is attached to base 200 and vice versa.

The first horizontal support member 240 includes first and second opposite ends 340 and 360, of which first end 340 is attached to first vertical member 220. First and second ends 340 and 360 define middle portion 380. The first end 340 of first horizontal support member 240 is attached to first vertical member 220 and vice versa as shown in FIG. 1B. In normal use, a harness apparatus 160 is connected to the middle portion 380 and an animal, such as dog D, is suspended therefrom over a treadmill track 180 as shown in FIG. 1A.

The second vertical member 260 is attached to the second end 360 of the first horizontal support member 240.

The second horizontal member 280 includes first and second opposite ends 400 and 420, and a middle portion 440 therebetween. The middle portion 440 is attached to the second vertical member 260 such that, although not directly connected to each other, first and second horizontal members 240 and 280 are approximately perpendicular with respect to each other.

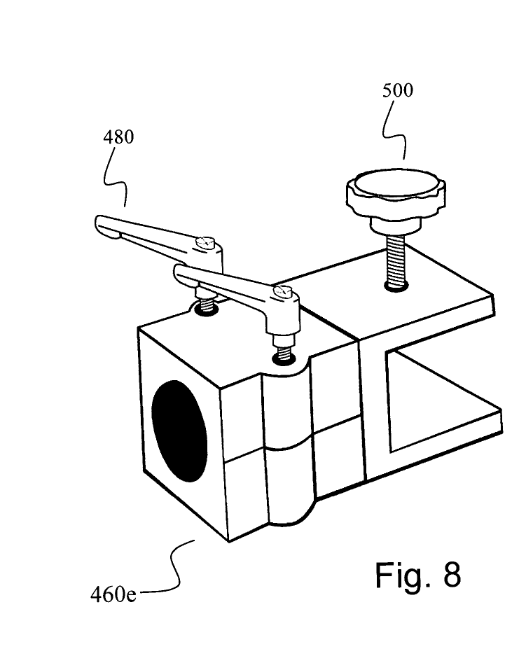

The second horizontal member 280 is movable up and down with respect to second vertical member 260 so that opposite ends 420 and 440 of the second horizontal member 280 can be attached to first and second treadmill support arms 140a and 140b of treadmill 120, respectively. Any suitable attachment apparatus can be used to attach opposite ends 420 and 440 to treadmill support arms 140a and 140b, such as, but not limited to, clamps 460 (actually represented by alpha-numeric labels “460a” and “460b”, respectively). Various kinds of clamps 460 are shown in FIGS. 5 through 8. For example, the ends of the second horizontal member 280 can be clamped to the first and second treadmill support arms 140a and 140b using two clamps of the type shown in FIG. 8; however, it should be expressly understood that any suitable clamp or attachment mechanism can be used to assemble or adjust the animal support apparatus 100.

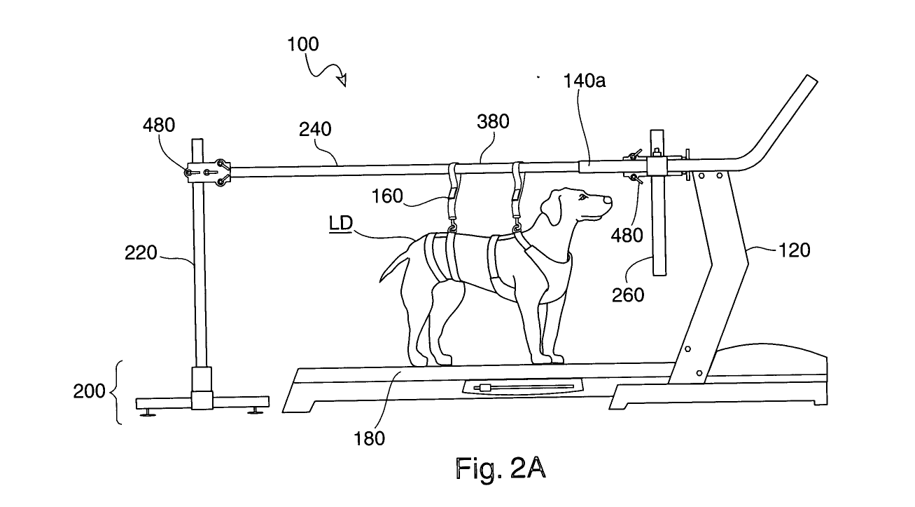

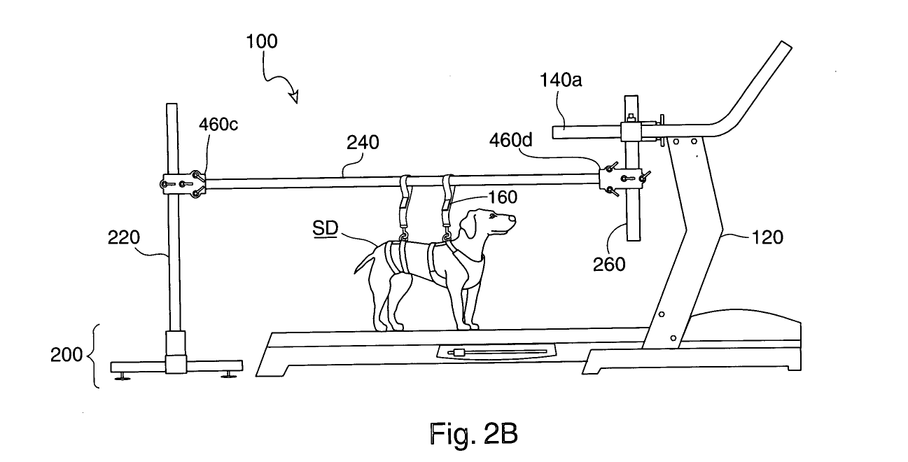

The functionality of second vertical member 260 is demonstrated in FIG. 2B. In FIG. 2B, a small dog SD is shown strapped to the middle portion 380 of first horizontal member 240. The small size of the dog necessitates lowering the first horizontal member 240. This is achieved by slackening clamps 460c and 460d and lowering the first horizontal member 240 a suitable distance with respect to first and second vertical members 220 and 260, and tightening the clamps 460c and 460d.

In FIG. 2A, a large dog LD is shown strapped to the middle portion 380 of first horizontal member 240, the size of the animal is such that there is no need to lower first horizontal member 240 with respect to second vertical member 260. The clamps 460c and 460d are shown fitted with quick release levers 480. The quick release levers can be replaced with any suitable locking mechanism such as the screw-lock mechanism 500 fitted to clamp 460e shown in FIG. 8.

The clamps 460 can take any suitable form and may include quick release levers 480 for ease of use. However, conventional nuts and bolts can be used in place of the quick release levers 480.

Non-limiting examples of suitable harnesses include front and/or rear harness available from WALKABOUT HARNESSES, PBM 277, 849 Almar Avenue, Suite C, Santa Cruz, Calif. 95060-5856 (TEL: 800-779-0439 or 831-427-1375, Fax: 831-427-1375). It should be understood that the term “harness” or “at least one harness” should be interpreted liberally; for example, the term harness is intended to cover dog belly harnesses or slings such as those supplied by WALKABOUT HARNESSES of Santa Cruz.

In another aspect of the invention, a physical therapy set-up for providing physical therapy to animals, comprises the animal support apparatus 100 in combination with the treadmill 120.

In another aspect of the invention, physical therapy is provided to animals by means of the steps: (1) supporting an animal above a treadmill by an animal harness 160 connected to the animal support apparatus 100; and (2) allowing at least one of the animal's feet to come into contact with the treadmill in such a manner that the treadmill aids the animal by exercising at least one leg of the animal.

It is to be understood that the present invention is not limited to the embodiments described above, but encompasses any and all embodiments within the scope of the following claims.

I claim:

1. An animal support apparatus for suspending an animal above a treadmill track, comprising:
a base;
a first vertical member having first and second opposite ends, wherein said first end of said first vertical member is attached to said base;
a first horizontal support member having first and second opposite ends and a middle portion defined therebetween, wherein said first end of said first horizontal support member is attached to said first vertical member;
a second vertical member attached to said second end of said first horizontal support member; and
a second horizontal member having first and second opposite ends and a middle portion defined therebetween, wherein said middle portion of said second horizontal member is attached to said second vertical member, wherein said first and second horizontal members are approximately perpendicular with respect to each other.

2. The animal support apparatus of claim 1, further comprising a plurality of quick release clamps.

3. The animal support apparatus according to claim 1, further comprising at least one animal harness attached to said first horizontal support member.

4. The animal support apparatus according to claim 1, further comprising a treadmill.

5. A physical therapy set-up for providing physical therapy to animals, comprising an animal support apparatus 100 in combination with a treadmill.

6. The physical therapy setup according to claim 5, further comprising at least one animal harness.

7. The physical therapy setup according to claim 6, wherein said at least one harness is adjustable for height.

8. A method for providing physical therapy to animals, comprising the steps of:
supporting an animal above a treadmill by an animal harness connected to an animal support apparatus; and
allowing at least one of the animal's feet to come into contact with the treadmill in such a manner that the treadmill aids the animal by exercising at least one leg of the animal.
